(19) United States
(12) Patent Application Publication
(10) Pub. No.: US 2004/0062401 A1
(43) Pub. Date: Apr. 1, 2004

(54) Audio channel translation

(76) Inventor: Mark Franklin Davis, San Francisco, CA (US)

Correspondence Address: Gallagher & Lathrop, Suite 1111, 601 California Street, San Francisco, CA, 94108-2805, US

(21) Appl. No.: 10/467,213

(22) PCT Filed: Feb. 7, 2002
(86) PCT No.: PCT/US02/03619

(51) Int. Cl. H04R 5/00; H04R 29/00; H04R 5/02

(52) U.S. Cl. 381/1; 381/18; 381/304; 381/56

(57) ABSTRACT

A process for translating M audio input channels representing a soundfield to N audio output channels representing the same soundfield, wherein each channel is a single audio stream representing audio arriving from a direction, M and N are positive whole integers, and M is at least 2, generates one or more sets of output channels, each set having one or more output channels. Each set is associated with two or more spatially adjacent input channels and each output channel in a set is generated by a process that includes determining a measure of the correlation of the two or more input channels and the level interrelationships of the two or more input channels.

### TECHNICAL FIELD

The invention relates to audio signal processing. More particularly the invention relates to translating M audio input channels representing a soundfield to N audio output channels representing the same soundfield, wherein each channel is a single audio stream representing audio arriving from a direction, M and N are positive whole integers, and M is at least 2.

### BACKGROUND ART

Although humans have only two ears, we hear sound as a three dimensional entity, relying upon a number of localization cues, such as head related transfer functions (HRTFs) and head motion. Full fidelity sound reproduction therefore requires the retention and reproduction of the full 3D soundfield, or at least the perceptual cues thereof. Unfortunately, sound recording technology is not oriented toward capture of the 3D soundfield, nor toward capture of a 2D plane of sound, nor even toward capture of a 1D line of sound. Current sound recording technology is oriented strictly toward capture, preservation, and presentation of zero dimensional, discrete channels of audio.

Most of the effort on improving fidelity since Edison's original invention of sound recording has focused on ameliorating the imperfections of his original analog modulated-groove cylinder/disc media. These imperfections included limited, uneven frequency response, noise, distortion, wow, flutter, speed accuracy, wear, dirt, and copying generation loss. Although there were any number of piecemeal attempts at isolated improvements, including electronic amplification, tape recording, noise reduction, and record players that cost more than some cars, the traditional problems of individual channel quality were arguably not finally resolved until the singular development of digital recording in general, and specifically the introduction of the audio Compact Disc. Since then, aside from some effort at further extending the quality of digital recording to 24 bits/96 kHz sampling, the primary efforts in audio reproduction research have been focused on reducing the amount of data needed to maintain individual channel quality, mostly using perceptual coders, and on increasing the spatial fidelity. The latter problem is the subject of this document.

Efforts on improving spatial fidelity have proceeded along two fronts: trying to convey the perceptual cues of a full sound field, and trying to convey an approximation to the actual original sound field. Examples of systems employing the former approach include binaural recording and two-speaker-based virtual surround systems. Such systems exhibit a number of unfortunate imperfections, especially in reliably localizing sounds in some directions, and in requiring the use of headphones or a fixed single listener position.

For presentation of spatial sound to multiple listeners, whether in a living room or a commercial venue like a movie theatre, the only viable alternative has been to try to approximate the actual original sound field. Given the discrete channel nature of sound recording, it is not surprising that most efforts to date have involved what might be termed conservative increases in the number of presentation channels. Representative systems include the panned-mono three-speaker film soundtracks of the early 50's, conventional stereo sound, quadraphonic systems of the 60's, five channel discrete magnetic soundtracks on 70 mm films, Dolby surround using a matrix in the 70's, AC-3 5.1 channel sound of the 90's, and recently, Surround-EX 6.1 channel sound. “Dolby”, “Pro Logic” and “Surround EX” are trademarks of Dolby Laboratories Licensing Corporation. To one degree or another, these systems provide enhanced spatial reproduction compared to monophonic presentation. However, mixing a larger number of channels incurs larger time and cost penalties on content producers, and the resulting perception is typically one of a few scattered, discrete channels, rather than a continuum soundfield. Aspects of Dolby Pro Logic decoding are described in U.S. Pat. No. 4,799,260, which patent is incorporated by reference herein in its entirety. Details of AC-3 are set forth in “Digital Audio Compression Standard (AC-3),” Advanced Television Systems Committee (ATSC), Document A/52, Dec. 20, 1995 (available on the World Wide Web of the Internet at www.atsc.org/Standards/A52/a_{—}52.doc). See also the Errata Sheet of Jul. 22, 1999 (available on the World Wide Web of the Internet at www.dolby.com/tech/ATSC_err.pdf.

### Insights Underlying Aspects of the Present Invention

The basis for recreating an arbitrary distribution in a source-free wave medium is provided by a theorem by Gauss that stipulates that a wave field within some region is completely specified by the pressure distribution along the boundary of the region. This implies that re-creation of the sound field in a concert hall within the confines of a living room is possible by conceptually placing the living room, walls impermeable to sound, within the concert hall, then electronically rendering the walls sonically transparent by festooning the outside of the walls with an infinite number of infinitesimal microphones, each connected with suitable amplification to a corresponding loudspeaker just inside the wall. By interposing a suitable recording medium between microphones and speakers, a complete, if impractical, system of accurate 3D sound reproduction is realized. The only remaining design task is to render the system practical.

A first step toward practicality can be taken by noting the signal of interest is bandlimited, at about 20 kHz, permitting the application of the Spatial Sampling theorem, a variant of the more common Temporal Sampling theorem. The latter holds that there is no loss of information if a continuous bandlimited temporal waveform is discretely sampled at a rate at least twice the highest frequency of the source. The former theory follows from the same considerations to stipulate that the spatial sampling interval must by at least twice as dense as the shortest wavelength in order to avoid information loss. Since the wavelength of 20 kHz in air is about ⅜″, the implication is that an accurate 3D sound system can be implemented with an array of microphones and loudspeakers spaced no more than 3/16″ apart. Extended over all surfaces of a typical 9′×12′ room, this works out to about 2.5 million channels, a considerable improvement over an infinite number, but still impractical at this time. Still, it establishes the basic approach of using an array of discrete channels as spatial samples, from which the sound field can be recovered by application of appropriate interpolation.

Once the sound field is characterized, it is possible in principle for a decoder to derive the optimal signal feed for any output loudspeaker. The channels supplied to such a decoder will be referred to herein variously as “cardinal,” “transmitted,” and “input” channels, and any output channel with a location that does not correspond to the position of one of the cardinal channels will be referred to as an “intermediate” channel. An output channel may also have a location coincident with the position of a cardinal input channel.

It is therefore desirable to reduce the number of discrete channel spatial samples, or cardinal channels. One possible basis for doing so is the fact that, above 1500 Hz, the ear no longer follows individual cycles, only the critical band envelope. This might allow channel spacing commensurate with 1500 Hz, or about 3″. This would reduce the total for the 9′×12′ room to about 6000 channels, a useful saving of about 2.49 million channels compared to the previous arrangement.

In any case, further reduction in the number of spatial sampling channels is theoretically possible by appeal to psychoacoustic localization limits. The horizontal limit of resolution, for centered sounds, is about 1 degree of arc. The corresponding limit of vertical resolution is about 5 degrees. If this density is extended appropriately around a sphere, the result will still be a few hundred to a few thousand channels.

### DISCLOSURE OF THE INVENTION

In accordance with the present invention, a process translates M audio input channels representing a soundfield to N audio output channels representing the same soundfield, wherein each channel is a single audio stream representing audio arriving from a direction, M and N are positive whole integers, and M is at least two. One or more sets of output channels are generated, each set having one or more output channels. Each set is associated with two or more spatially adjacent input channels and each output channel in a set is generated by a process that includes determining a measure of the correlation of the two or more input channels and the level interrelationships of the two or more input channels.

In one aspect of the present invention, multiple sets of output channels are associated with more than two input channels and the process determines the correlation of input channels with which each set of output channels is associated according to a hierarchical order such that each set or sets is ranked according to the number of input channels with which its output channel or channels are associated, the greatest number of input channels having the highest ranking, and the processing processes sets in order according to their hierarchical order. Further according to an aspect of the present invention, the processing takes into account the results of processing higher order sets.

The playback or decoding aspects of the present invention assume that each of the M audio input channels representing audio arriving from a direction was generated by a passive-matrix nearest-neighbor amplitude-panned encoding of each source direction (i.e., a source direction is assumed to map primarily to the nearest cardinal channel or channels), without the requirement of additional side chain information (the use of side chain or auxiliary information is optional), making it compatible with existing mixing techniques, consoles, and formats. Although such source signals may be generated by explicitly employing a passive encoding matrix, most conventional recording techniques inherently generate such source signals (thus, constituting an “effective encoding matrix”). The playback or decoding aspects of the present invention are also largely compatible with natural recording source signals, such as might be made with five real directional microphones, since, allowing for some possible time delay, sounds arriving from intermediate directions tend to map principally to the nearest microphones (in a horizontal array, specifically to the nearest pair of microphones).

A decoder or decoding process according to aspects of the present invention may be implemented as a lattice of coupled processing modules or modular functions (hereinafter, “decoding modules”), each of which is used to generate one or more output channels (or, alternatively, control signals usable to generate one or more output channels) from the two or more of the closest spatially adjacent cardinal channels associated with the decoding module. The output channels represent relative proportions of the audio signals in the closest spatially adjacent cardinal channels associated with the particular decoding module. As explained in more detail below, the decoding modules are loosely coupled to each other in the sense that modules share nodes and there is a hierarchy of decoding modules. Modules are ordered in the hierarchy according to the number of cardinal channels they are associated with (the module or modules with the highest number of associated cardinal channels is ranked highest). A supervisory routine function presides over the modules so that common node signals are equitably shared and higher-order decoder modules may affect the output of lower-order modules.

Each decoder module may, in effect, include a matrix such that it directly generates output signals or each decoder module may generate control signals that are used, along with the control signals generated by other decoder modules, to vary the coefficients of a variable matrix or the scale factors of inputs to or outputs from a fixed matrix in order to generate all of the output signals.

Decoder modules emulate the operation of the human ear to attempt to provide perceptually transparent reproduction. Each decoder module may be implemented as either a wideband or multiband structure or function, in the latter case with either a continuous filterbank, or a block-structure, for example, a transform-based processor, using, for example, the same essential processing in each band.

Although the basic invention relates generally to the spatial translation of M input channels to N output channels, wherein M and N are positive whole integers and M is at least two, another aspect of this invention is that the quantity of speakers receiving the N output channels can be reduced to a practical number by judicious reliance upon virtual imaging, that is the creation of perceived sonic images at positions in space other than where a loudspeaker is located. The most common use of virtual imaging is in the stereo reproduction of an image part way between two speakers, by panning a mono signal between the channels. Virtual imaging is not considered a viable technique for group presentation with a sparse number of channels, because it requires the listener to be equidistant from the two speakers, or nearly so. In movie theatres, for example, the left and right front speakers are too far apart to obtain useful phantom imaging of a center image to much of the audience, so, given the importance of the center channel as the source of much of the dialog, a physical center speaker is used instead.

However, as the density of the speakers is increased, a point will be reached where virtual imaging is viable between any pair of speakers for much of the audience, at least to the extent that pans are smooth; with sufficient speakers, the gaps between the speakers are no longer perceived as such. Such an array has the potential to be nearly indistinguishable from the 2 million array derived earlier.

In order to test aspects of the present invention, we deployed a horizontal array of 5 speakers on each wall, 16 total allowing for common corner speakers, plus a ring of 6 speakers above the listener at a vertical angle of about 45 degrees, plus a single speaker directly above, total 23, plus a subwoofer/LFE channel, total 24, all fed from a PC set up for 24-channel playback. Although by current parlance this system might be referred to as a 23.1 channel system, for simplicity it will be referred to as a 24-channel system herein.

FIG. 1 is a top plan view showing schematically an idealized decoding arrangement in the manner of the just-described test arrangement. Five wide range horizontal cardinal channels are shown as squares 1′, 3′, 5′, 9′ and 13′ on the outer circle. A vertical channel, perhaps derived from the five wide range cardinals via correlation or generated reverberation, or separately supplied, is shown as the broken square 23′ in the center. The twenty-three wide range output channels are shown as numbered filled circles 1-23. The outer circle of sixteen output channels is on a horizontal plane, the inner circle of six output channels is forty-five degrees above the horizontal plane. Output channel 23 is directly above one or more listeners. Five two-input decoding modules are illustrated as arrows 24-28 around the outer circle, connected between each pair of horizontal cardinal channels. Five additional two-input vertical decoding modules are illustrated as arrows 29-33 connecting the vertical channel to each of the horizontal cardinals. Output channel 21, the elevated center rear channel, is derived from a three-input decoding module illustrated as arrows between output channel 21 and cardinal channels 9, 13 and 23. Thus, each module is associated with a respective pair or trio of closest spatially adjacent cardinal channels. Although the decoding modules represented in FIG. 1 have three, four or five output channels, a decoding module may have any reasonable number of output channels. An output channels may be located intermediate to one or more cardinal channels or at the same position as a cardinal channel. Thus, in the FIG. 1 example, each of the cardinal channel locations is also an output channel. Two or three decoding modules share each input channel.

As will be discussed, a design goal of this invention is that the playback processor should be capable in concept of working with an arbitrary number and arrangement of speakers, so the 24-channel array will be used as an illustrative but non-unique example of the density and arrangement required to achieve a convincing continuum perceived soundfield according to one aspect of the invention.

The desire to be able to use a large, and possibly user-selectable, number of presentation channels raises the question of the number of discrete channels, and/or other information, that must be conveyed to the playback processor in order for it to derive, at least as one option, the twenty four channels described above. Obviously, one possible approach is simply to transmit twenty four discrete channels, but aside from the fact that it would likely be onerous for content producers to have to mix that many separate channels, and for a transmission medium to convey as many channels, it is preferred not to do so, as the 24-channel arrangement is merely one of many possible, and it is desired to allow for more or fewer presentation channels from a common transmitted signal array.

One way to recover output channels is to use formal spatial interpolation, a fixed weighted sum of the transmitted channels for each output, assuming the density of such channels is sufficiently great to allow for that. However, this would require from thousands to millions of transmitted channels, analogous to the use of a multi-hundred-tap FIR filter to perform temporal interpolation of a single signal. Reduction to a practical number of transmitted channels requires the application of psychoacoustic principles and more aggressive, dynamic interpolation from far fewer channels, still leaving unanswered the question of just how many channels are needed to impart the percept of a complete soundfield.

This question was addressed by an experiment performed by the present inventor some years ago, and recently replicated by another. The basis for the earlier experiment, at least, was the observation that conventional 2-channel binaural recording is capable of reproducing a realistic left/right image spread, but results in erratic front/back localization, owing in part to the imperfection of any HRTF employed, and the lack of head motion cues. To circumvent this drawback, a dual-binaural (4-channel) recording was made, using two pairs of directional microphones spaced commensurate to the size of the human head. One pair faced forward, the other to the rear. The resulting recording was played over four speakers spaced close to the head, to mitigate acoustic cross coupling effects. This arrangement provided realistic left/right timing and amplitude localization cues from each pair of speakers, plus unambiguous front/back information from the corresponding discrete positions of the microphones and speakers. The result was a singularly compelling surround sound presentation that lacked only a viable representation of height information. A recent experiment of another added a center front channel and two height channels, and was reported to be similarly realistic, perhaps even enhanced by the addition of height information.

Therefore, from both psychoacoustic considerations and empirical evidence, it appears that the relevant perceptual information can be conveyed in perhaps 4 to 5 “binaural-like” horizontal channels, plus perhaps one or more vertical channels. However, the signal crossfeed characteristic of binaural channel pairs makes them unsuitable for direct playback to a group via loudspeakers, since there is very little separation at midrange and low frequencies. So rather than introducing the crossfeed at the encoder (as is done for a binaural pair) only to have to undo it in the decoder, it is simpler and more direct to keep channels isolated, and to mix output channel signals from the nearest transmitted channels. Not only does this allow for direct playback through a like number of speakers without a decoder, if desired, plus optional downmix to fewer channels with a passive matrix decoder, but it essentially corresponds to the existing standard arrangement of 5.1 channels, at least in the horizontal plane. It is also largely compatible with natural recordings, such as might be made with five real directional microphones, since, allowing for some possible time delay, sounds arriving from intermediate directions will tend to map principally to the nearest microphones (in a horizontal array, specifically to the nearest pair of microphones).

Thus, from a perceptual standpoint, it should be possible for a channel translation decoder to accept a standard 5.1 channel program and convincingly present it through an arbitrary number of horizontally arrayed speakers, including the sixteen horizontal speakers of the twenty-four-channel array described earlier. With the addition of a vertical channel, such as is sometimes proposed for a digital cinema system, it should be possible to feed the entire twenty-four-channel array with individually derived, perceptually valid signals that together impart a continuum soundfield percept at most listening positions. Of course, if there is access to the fine grain source channels at the encoding site, additional information about them might be used to actively alter the encode matrix scale factors to pre-compensate for decoder limitations, or might simply be included as additional side-chain (auxiliary) information, perhaps similar to the coupling coordinates used in AC-3 (Dolby Digital) multichannel coding, but perceptually, such extra information should not be necessary; and practically, requiring the inclusion of such information is undesirable. The intended operation of the channel translation decoder is not limited to operation with 5.1 channel sources, and may use fewer or more, but there is at least some justification to the belief that credible performance can be obtained from 5.1 channel sources.

This still leaves unanswered the question of just how to extract the intermediate output channels from a sparse array of transmitted channels. The solution proposed by one aspect of the present invention is to exploit again the notion of virtual imaging, but in a somewhat different way. It was previously noted that virtual imaging is not viable for group presentation with sparse speaker arrays because it required the listener to be nearly equidistant from each speaker. But it will work, after a fashion, for a listener who is fortuitously so placed, allowing the percept of intermediate phantom channels for signals that have been amplitude panned between the nearest real output channels. It is therefore proposed in one aspect of the present invention that the channel translation decoder consist of a series of modular interpolating signal processors, each in effect emulating an optimally placed listener, and each functioning in a manner analogous to the human auditory system to extract what would otherwise be virtual images from amplitude-panned signals, and feed them to real loudspeakers; the speakers preferably arrayed densely enough that natural virtual imaging can fill in the remaining gaps between them.

In general, each decoding module derives its inputs from the nearest transmitted cardinal channels, which, for example, for a canopy (overhead) array of speakers may be three or more cardinal channels. One way of generating output channels involving more than two cardinal channels might be to employ a series of pair-wise operations, with, e.g., outputs of some pair-wise decoding modules feeding the inputs of other modules. However, this has two drawbacks. One is that cascading decoding modules introduces multiple cascaded time constants, resulting in some output channels responding more quickly than others, causing audible position artifacts. The second drawback is that pair-wise correlation alone can only place intermediate or derived output channels along the line between the pair; use of three or more cardinals removes this restriction. Consequently, an extension to common pair-wise correlation has been developed to correlate three or more output signals; this technique is described below.

Horizontal localization in the human ear is predicated primarily upon two localization cues: interaural amplitude differences and interaural time differences. The latter cue is only valid for signal pairs in near time alignment, ±600 microseconds or so. The practical effect is that phantom intermediate images will only occur at positions corresponding to a particular left/right amplitude difference, assuming the common signal content in the two real channels is correlated, or nearly so. (Note: two signals can have cross correlation values that span from +1 to −1. Fully correlated signals (correlation=1) have the same waveform and time alignment, but may have different amplitudes, corresponding to off-center image positions.) As the correlation of a signal pair diminishes below 1, the perceived image will tend to spread, until, for two uncorrelated signals, there will be no intermediate image, only separate and distinct left and right images. Negative correlations are usually treated by the ear as similar to uncorrelated signal pairs, although the two images may appear to be spread wider. The correlations are carried out on a critical band basis, and above about 1500 Hz, the critical band signal envelopes are used instead of the signals themselves, to save human computational requirements (MIPS).

Vertical localization is a little more complex, relying on HRTF pinna cues and dynamic modulation of the horizontal cues with head motion, but the final effect is similar to horizontal localization with respect to panned amplitudes, cross correlation, and corresponding perceived image position and fusion. Vertical spatial resolution is, however, less precise than horizontal resolution, and does not require as dense an array of cardinal channels for adequate interpolation performance.

An advantage of using directional processors that emulate the operation of the human ear is that any imperfections or limitations of the signal processing should be perceptually masked by like imperfections and limitations of the human ear, allowing for the possibility that the system will be perceived as nearly indistinguishable from the original full continuum presentation.

Although the present invention is designed to make effective use of however many or few output channels are available (including playback via as many loudspeakers as there are input channels with no decoding, and passive mixdown to fewer channels, including mono, stereo and surround compatible Lt/Rt), it is preferably intended to employ a large and somewhat arbitrary, but nonetheless practical number of presentation channels/loudspeakers, and use as source material a similar or smaller number of encoded channels, including existing 5.1 channel surround tracks, and possible next-generation 11- or 12-channel digital cinema soundtracks.

Implementations of the present invention desirably should exhibit four principles: error containment, dominant containment, constant power, and synchronized smoothing.

Error containment refers to the notion that, given the likelihood of decoding errors, the decoded position of each source should be in some reasonable sense near its true, intended direction. This mandates a certain degree of conservatism in decoding strategy. Faced with the prospect of more aggressive decoding accompanied by possibly greater spatial disparity in the event of errors, it is usually preferable to accept less precise decoding in exchange for assured spatial containment. Even in situations in which more precise decoding can confidently be applied, it may be unwise to do so if there is a likelihood that dynamic signal conditions will require the decoder to ratchet between aggressive and conservative modes, resulting in audible artifacts.

Dominant containment, a more constrained variant of error containment, is the requirement that a single well-defined dominant signal should be panned by the decoder to only nearest neighbor output channels. This condition is necessary to maintain image fusion for dominant signals, and contributes to the perceived discreteness of a matrix decoder. While a signal is dominant, it is suppressed from other output channels, either by subtracting it from the associated cardinal signals, or by directly applying to other output channels matrix coefficients complementary to those used to derive the dominant signal (“anti-dominant coefficients/signal”).

Constant power decoding requires not only that the total decoded output power be equal to the input power, but also equates the input/output power of each channel and directional signal encoded in the conveyed cardinal array. This minimizes gain-pumping artifacts.

Synchronized smoothing applies to systems with signal dependent smoothing time constants, and requires that if any smoothing network within a decoding module is switched to a fast time constant mode, all other smoothing networks within the module be similarly switched. This is to avoid having a newly dominant directional signal appear to slowly fade/pan from the previous dominant direction.

### DESCRIPTION OF THE DRAWINGS

FIG. 1 is a schematic drawing showing a top plan view of an idealized decoder arrangement.

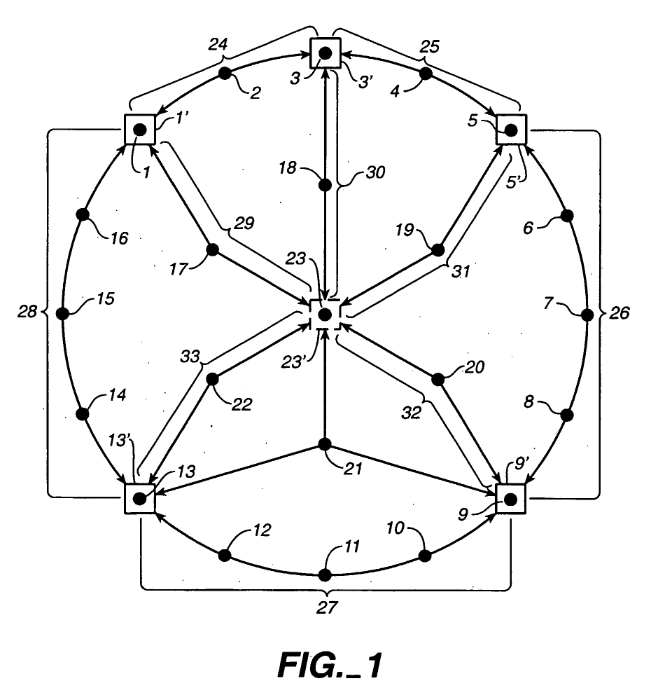

### BEST MODE FOR CARRYING OUT THE INVENTION

### Decoding Module

Because encoding any source direction is assumed to map primarily to the nearest cardinal channels, channel translation decoding is based on a series of semi-autonomous decoding modules which in a general sense recover output channels, particularly intermediate output channels, each usually from a subset of all the transmitted channels, in a fashion similar to the human ear.

In a fashion analogous to the human ear, the operation of the decoding module is based on a combination of amplitude ratios, to determine the nominal ongoing primary direction, and cross correlation, to determine the relative width of the image.

Using control information derived from the amplitude ratios and cross correlation, the processor then extracts output channel audio signals. Since this is best done on a linear basis, to avoid generation of distortion products, the decoder forms weighted sums of cardinal channels containing the signal of interest. (As explained below, it may also be desirable to include information about non-neighbor cardinals in the calculation of the weighted sum.) This limited but dynamic form of interpolation is more commonly referred to as matrixing. If, in the source, the desired signal is mapped (amplitude panned) to the nearest M cardinal channels, then the problem is one of M:N matrix decoding. In other words, the output channels represent relative proportions of the input channels.

Especially in the case of two-input decoding modules, this is much like the issue addressed by active 2:N matrix decoders, such as the now classic Dolby Pro Logic matrix decoder, with pairwise decoding module inputs corresponding to the Lt/Rt encoded signals.

Note: The outputs of a 2:N matrix decoder are sometimes referred to as cardinal channels. This document, however, uses “cardinal” to refer to the input channels of the channel translation decoder.

There is, however, at least one significant difference between prior art active 2:N decoders and the operation of a decoding module according to the present invention. While the former use left/right amplitudes to indicate left/right position, as postulated as well for the channel translation decoder, they also use interchannel phase to indicate front/back position, relying specifically on the ratio of sum/difference of the Lt/Rt encoded channels.

There are two problems with such active 2:N decoder arrangements. One is that fully correlated (frontal), but off-center signals, for example, will result in a sum/difference ratio of less than infinity, incorrectly indicating a less-than-full-frontal position (similarly for full anti-correlated off-center rear signals). The result is a somewhat warped decoding space. The second drawback is that the positional mapping is many-to-one, introducing inherent decoding errors. For example, in a 4:2:4 matrix system, an uncorrelated Left-In and Right-In signal pair with no Front-In or Rear-In will map to the same net, uncorrelated Lt/Rt pair as will an uncorrelated Front-In/Back-In pair, with no Left-In/Right-In, or for that matter from all four inputs uncorrelated. The decoder, faced with an uncorrelated Lt/Rt signal pair, has no choice but to “relax the matrix”, that is use a passive matrix that distributes sound to all output channels. It is incapable of decoding to a simultaneous Left-Out/Right-Out only, or Front-Out/Rear-Out only signal array.

The underlying problem is that the use of interchannel phase to code front/back position in N:2:N matrixing systems runs counter to the operation of the human ear, which does not use phase to judge front/back position. The present invention works best with at least three non-collinear cardinal channels, so that front/back position is indicated by the assumed directions of the cardinal channels, without assigning different directions depending on their relative phases or polarities. As such, a pair of uncorrelated or anti-correlated channel translation cardinal signals unambiguously decodes to isolated cardinal-output channel signals, with no intermediate signal and no “rearward” direction indicated. (This, by the way, avoids the unfortunate “center pileup” effect in active 2:N decoders, in which uncorrelated Left-In and Right-In signals are presented with reduced separation because the decoder feeds sum and difference of these signals to center and surround channels.) Of course, it is possible in principle to spatially expand a Lt/Rt signal pair by cascading a 2:N decoder, N=4, or 5, with an N:M channel translation system, but in that case any limitations of the 2:N decoder, such as center pileup, will be carried over to the channel multiplied outputs. It is also possible to combine these functions into a channel translation decoder configured to accept 2-channel Lt/Rt signals and, in such cases, modify its behavior to interpret negative correlation signals as having rearward orientation, leaving the rest of the processing largely intact. However, even in that case, decoding ambiguities resulting from having only two transmitted channels would remain.

Thus, each decoding module, especially those with two input channels, resembles a prior art active 2:N decoder, with the front/back detection disabled or modified, and an arbitrary number of output channels. Of course, it is a mathematical impossibility to use matrixing to uniquely extract a larger number of channels from a smaller number, as this basically involves N linear equations with M unknowns, M greater than N. Therefore, it is to be expected that the decoding module may at times exhibit less than perfect channel recovery in the presence of multiple active source direction signals. However, the human auditory system, limited to using just two ears, will tend to be subject to the same limitations, allowing the system to be perceived as discrete, even with all channels operating. Isolated channel quality, with other channels muted, is still a consideration to accommodate listeners that may be situated near one speaker.

To be sure, the ear is operating on a frequency-dependent basis, but given that most sonic images will be similarly correlated at all frequencies, together with the successful empirical experience with Pro Logic decoders as a wideband system, it is to be expected that a wideband channel translation system may also be capable of satisfactory performance in some applications. Multiband channel translation decoding should also be possible, using similar processing on a band-by-band basis, and using the same encoded signal in each case, so the number and bandwidth of individual bands can be left as a free parameter to the decoder implementer. Although multiband processing is likely to require higher MIPS than wideband processing, the computational demands may not be that much higher if the input signals are divided into data blocks and the process is carried out on a block basis.

Before describing an algorithm usable by the decoding modules of the present invention, consideration is first given to the problem of shared nodes.

### Shared Nodes

If the cardinal channel groups used by the decoding modules were all independent, then the decoding modules themselves could be independent, autonomous entities. Such is, however, not usually the case. A given transmitted channel will in general share separate output signals with two or more neighboring cardinal channels. If independent decoding modules are used to decode the array, each will be influenced by output signals of neighboring channels, resulting in possibly serious decoding errors. In effect, two output signals of neighboring decoding modules will “pull”, or gravitate, toward each other, because of the increased level of the common cardinal node containing both signals. If, as is likely to be the case, the signals are dynamic, so too will be the amount of interaction, leading to signal dependent dynamic positioning errors of a possibly highly objectionable nature. This problem does not arise with Pro Logic and other active 2:N decoding, since they use only a single, isolated channel pair as the decoder input.

Thus, it is necessary to compensate for the “shared node” effect. One possible way to do so would be to subtract one recovered signal from the common node before trying to recover the output signal of an adjacent decoding module sharing the common node. This is often not possible, so as a fall back, each decoding module estimates the amount of common output signal energy present at its input channels, and a supervisor routine then informs each module of its neighbors' output signal energy estimates.

### Pair-Wise Calculation of Common Energy

For example, suppose cardinal channel pair A/B contains a common signal X along with individual, uncorrelated signals Y and Z:

A=0.707X+Y

B=0.707X+Z

where the scalefactors of 0.707=\sqrt{0.5} provide a power preserving mapping to the nearest neighbor cardinal channels.

$$\begin{matrix}RMS Energy ( A ) = \int {A}^{2} \partial t = \overline{{A}^{2}} = \overline{{( .707 X + Y )}^{2}} \\ = \overline{( 0.5 {X}^{2} + 0.707 XY + {Y}^{2} )} \\ = 0.5 \overline{{X}^{2}} + 0.707 \overline{XY} + \overline{{Y}^{2}}\end{matrix}$$

Because X and Y are uncorrelated,

\overline{XY}=0

So:

\overline{A²}=0.5\overline{X²}+\overline{Y²}

i.e., Because X and Y are uncorrelated, the total energy in cardinal channel A is the sum of the energies of signals X and Y.

Similarly:

\overline{B²}=0.5\overline{X²}+\overline{Z²}

Since X, Y, and Z are uncorrelated, the averaged cross-product of A and B is:

\overline{AB}=0.5\overline{X²}

So, in the case of an output signal shared equally by two neighboring cardinal channels which may also contain independent, uncorrelated signals, the averaged cross-product of the signals is equal to the energy of the common signal component in each channel. If the common signal is not shared equally, i.e., it is panned toward one of the cardinals, the averaged cross-product will be the geometric mean between the energy of the common components in A and B, from which individual channel common energy estimates can be derived by normalizing by the square root of the ratio of the channel amplitudes. Actual time averages are computed with a leaky integrator having a suitable decay time constant, to reflect ongoing activity. The time constant smoothing can be elaborated with nonlinear attack and decay time options, and in a multiband system, may be scaled with frequency.

### Higher Order Calculation of Common Energy

In order to derive the common energy of decoding modules with three or more inputs, it is necessary to form averaged cross-products of all the input signals. Simply performing pairwise processing of the inputs will fail to differentiate between separate output signals between each pair of inputs and a signal common to all.

Consider, for example, three cardinal channels, A, B, and C, made up of uncorrelated signals W, Y, Z, and common signal X:

A=X+W

B=X+Y

C=X+Z

If the average cross-product is calculated, all terms involving combinations of W, Y, and Z will cancel, as in the second order calculation, leaving the average of X³:

\overline{ABC}=\overline{X³}

Unfortunately, if X is a zero mean time signal, as expected, then the average of its cube is zero. Unlike averaging X², which is positive for any nonzero value of X, X³ has the same sign as X, so the positive and negative contributions will tend to cancel. Obviously, the same holds for any odd power of X, corresponding to an odd number of module inputs, but even exponents greater than 2 can also lead to erroneous results; for example four inputs with components (X, X, −X, −X) will have the same product/average as (X, X, X, X).

This problem has been resolved by employing a variant of the averaged product technique. Before being averaged, the sign of the each product is discarded by taking the absolute value of the product. The signs of each term of the product are examined. If they are all the same, the absolute value of the product is applied to the averager. If any of the signs are different from the others, the negative of the absolute value of the product is averaged. Since the number of possible same-sign combinations may not be the same as the number of possible different-sign combinations, a weighting factor comprised of the ratio of the number of same to different sign combinations is applied to the negated absolute value products to compensate. For example, a three-input module has two ways for the signs to be the same, out of eight possibilities, leaving six possible ways for the signs to be different, resulting in a scale factor of 2/6=⅓. This compensation causes the integrated or summed product to grow in a positive direction if and only if there is a signal component common to all inputs of a decoding module.

However, in order for the averages of different order modules to be comparable, they must all have the same dimensions. A conventional second-order correlation involves averages of two-input multiplications and hence of quantities with the dimensions of energy or power. Thus the terms to be averaged in higher order correlations must be modified also to have the dimensions of power. For a kth order correlation, the individual product absolute values must therefore be raised to the power 2/k before being averaged.

Of course, regardless of the order, the individual input node energies of a module, if needed, can be calculated as the average of the square of the corresponding node signal, and need not be first raised to the kth power and then reduced to a second order quantity.

### Shared Nodes: Neighbor Levels

By using averaged squares and modified cross-products of cardinal channel signals, the amount of common output channel signal energy can be estimated. The above example involved a single interpolation processor, but if one or more of the A/B(/C) nodes were common to another module with its own common signal component, uncorrelated with any other signals, then the averaged cross-product computed above would not be affected, making the calculation inherently free of any image pulling effects. (Note: if the two output signals are not uncorrelated, they will tend to pull the decoders some, but should have a similar effect on the human ear, so again system operation should remain faithful to human audition.)

Once each decoding module has computed the estimated common output channel signal energy at each of its cardinal nodes, the supervisor routine function can inform neighboring modules of each others' common energy, at which point the extraction of the output channel signals can proceed as described below. The calculation of the common energy used by a module at a node must take into account the hierarchy of possibly overlapping modules of different order, and subtract the common energy of a higher order module from the estimated common energy of any lower order module sharing the same nodes.

For example, suppose there are two adjacent cardinal channels A and B, representing two horizontal directions, plus a cardinal channel C, representing a vertical direction, and further suppose the existence of an intermediate or derived output channel representing an interior direction (i.e. one within the limits of A, B and C), with signal energy X². The common energy of a three-input module, with inputs (A, B, C), will be X², but so will the common energy of two-input modules (A, B), (B, C), and (A, C). If the common energy of A-connected modules (A, B, C), (A, B), and (A, C) is simply added, the result is 3X², instead of X². In order for the calculation of common node energy to be correct, the common energy of each higher order module is first subtracted from the estimate of the common energy of each overlapping lower-level module, so the common energy X² of higher order module (A, B, C) is subtracted from the common energy estimates of the two two-input modules, resulting in 0 in each case, and making the net common energy estimate at node A equal to X²+0+0=X².

### Output Channel Signal Extraction

As has been noted, the process of recovering the ensemble of output channels from the transmitted channels in a linear fashion is basically one of matrixing, that is forming weighted sums of the cardinal channels to derive output channel signals. The optimal choice of matrix scale factors is generally signal dependent. Indeed, if the number of currently active output channels is equal to the number of transmitted channels (but representing different directions), making the system exactly constrained, it is mathematically possible to compute an exact inverse of the effective encoding matrix, and recover isolated versions of the source signals. Even if the number of active output channels is greater than the number of cardinals, it may still be possible to compute a matrix pseudo-inverse.

Unfortunately, there are problems with this approach, not the least of which is that it is computationally demanding, especially on a multiband basis, and oriented toward high accuracy floating point implementation. Even though intermediate signals are assumed to be panned to nearest neighbor cardinal channels, a mathematical inverse or pseudo-inverse of the effective encoding matrix will in general involve contributions from all cardinal channels to each output channel, because of the node sharing effect. If there are any imperfections in the decoding, as indeed there inevitably will be, a cardinal channel signal could be reproduced from an output channel far removed from it spatially, which is highly undesirable. In addition, pseudo-inverse calculations tend to produce minimum-RMS-energy solutions, which maximally spread the sound around, providing minimum separation; this is quite the opposite of the intention.

So, in order to implement a practical, fault-tolerant decoder in which spatial decoding errors are inherently contained, the same modular structure as was used for signal detection is employed for signal extraction.

Following are details of the extraction process by which output signals are recovered by a decoding module. Note that the effective position of each output channel connected to the module is assumed to be indicated by the amplitude ratio that would otherwise be needed to pan a signal to that physical location, i.e., the ratio of the effective matrix encoding coefficients corresponding to that direction. To avoid divide-by-zero problems, ratios are typically calculated as the quotient of one channel's matrix coefficient over the RMS sum of all of that input channels' matrix coefficients (usually 1). For example, in a two-input module with inputs L and R, the energy ratio used would be the L energy over the sum of the L and R energies (“L-ratio”), which has a well-behaved range of 0 to 1. If the two-input decoding module has five output channels with effective encoding matrix coefficient pairs of (1.0, 0), (0.89, 0.45), (0.71, 0.71), (0.45, 0.89) and (0, 1.0), the corresponding L-ratios are 1.0, 0.89, 0.71, 0.45, and 0, since each scale factor pair has an RMS sum of 1.0.

From the signal energy of each input node (cardinal channel) of the decoding module is subtracted any node-sharing signal energy claimed by neighboring decoding modules, resulting in normalized input signal power levels used for the remainder of the calculation.

The dominant direction indicator is calculated as the vector sum of the cardinal directions, weighted by the relative energy. For a two input module, this simplifies to being the L-ratio of the normalized input signal power levels.

The output channels bracketing the dominant direction are determined by comparing the dominant direction L-ratio of step two, to the L-ratios of the output channels. For example, if the L-ratio of the above five-output-decoding-module inputs is 0.75, the second and third output channels bracket dominant signal direction, since 0.89>0.75>0.71.

Panning scale factors to map the dominant signal onto the nearest bracketing channels are calculated from the ratio of the anti-dominant signal levels of the channels. The anti-dominant signal associated with a particular output channel is the signal that results when the corresponding decoding module's input signals are matrixed with the output channel's anti-dominant matrix scale factors. An output channel's anti-dominant matrix scale factors are those scale factors with RMS sum=1.0 which result in zero output when a single dominant signal is panned to the output channel in question. If an output channel's encode matrix scale factors are (A, B), then the anti-dominant scale factors of the channel are just (B, −A).

### Proof

If a single dominant signal is panned to an output channel with encode scale factors (A, B), then the signal must have amplitudes (kA, kB), k the overall amplitude of the signal. Then the anti-dominant signal for that channel is (kA*B−kB*A)=0.

So, if a dominant signal consists of two-input module input signals (x(t), y(t)) with input amplitudes normalized to RMS=1 (X, Y), the extracted dominant signal will be dom(t)=Xx(t)+Yy(t). If the position of this signal is bracketed by output channels having matrix scale factors (A, B) and (C, D) respectively, the dominant signal scale factor scaling dom(t) for the former channel will be:

SF(A,B)=sqrt((DX−CY)/((DX−CY)+(BX−AY))),

while the equivalent dominant signal scale factor for the latter channel will be:

SF(C,D)=sqrt((BX−AY)/((DX−CY)+(BX−AY))).

As the dominant direction is panned from one output channel to the other, these two scale factors move in opposite directions between zero and one with constant power sum.

The anti-dominant signal is calculated and panned with suitable gain scaling to all non-dominant channels. The anti-dominant signal is a matrixed signal lacking any of the dominant signal. If the inputs to a decoding module are (x(t), y(t)) with normalized amplitudes (X, Y), the dominant signal is Xx(t)+Yy(t) and the anti-dominant signal is Yx(t)−Xy(t), irrespective of the positions of the non-dominant output channels.

In addition to the dominant/anti-dominant signal distribution, a second signal distribution is calculated, using the “passive” matrix, which is basically the output channel matrix scale factors already discussed, scaled to preserve power.

The cross correlation of the decoding module input signals is calculated as the averaged cross-product of the input signals divided by the square root of the product of the normalized input levels.

Returning to details of the extraction process, the final output signals are then calculated as a weighted crossfade sum of the dominant and passive signal distributions, using the decoding module's input signal cross-correlation to derive the crossfade factor. For correlation=1, the dominant/anti-dominant distribution is used exclusively. As the correlation diminishes, the output signal array is broadened by cross-fading to the passive distribution, reaching completion at a low positive value of correlation, typically 0.2 to 0.4, depending on the number of output channels connected to the decoding module. As the correlation falls further, toward zero, the passive amplitude output distribution is progressively bowed outward, reducing the output channel levels, emulating the response of the human ear to such signals.

### Vertical Processing

Most of the processing described so far applies to the extraction of output channel signals from neighboring cardinal channels, regardless of the direction of the output and cardinal channels. However, because of the horizontal orientation of the ears, human auditory localization tends to be less sensitive to interchannel correlation in the vertical direction than horizontally. To remain faithful to the operation of the human ear, it may be desirable to relax the correlation constraint in interpolation processors using vertically-oriented input channels, such as processing the correlation signal with a warping function before otherwise applying it. However, it may be that use of the same processing as for horizontal channels will not involve any audible penalty, which will simplify the structure of the overall decoder.

Strictly speaking, vertical information includes both sound from above and below, and the decoder structure described will work equally well with either, but in practice there is little natural sound normally perceived as coming from below, so such processing and channels can probably be omitted without seriously compromising the perceived spatial fidelity of the system.

That notion may have practical significance in the application of channel translation to existing 5.1 channel surround material, which, of course, lacks any vertical channel. However, it may contain vertical information, such as fly-overs, which are panned across many or all of the horizontal channels. Thus, it should be possible to extract a virtual vertical channel from such source material, by looking for correlations among non-neighboring channels or groups of channels. Where such correlations exist, they will usually indicate the presence of vertical information from above, rather than below the listener. In some instances, it may also be possible to derive virtual vertical information from a reverberation generator, perhaps keyed to a model of the intended listening environment. Once the virtual vertical channel is extracted or derived from the 5.1-channel source, the expansion to larger numbers of channels, such as the 24-channel arrangement described earlier, can proceed as if a real vertical channel had been supplied.

### Directional Memory

One respect in which the operation of the decoding module control generation described above is similar to a 2:N active decoder such as a Pro Logic decoder is that the only “memory” in the process is in the smoothing networks, which derive the basic control signals. At any one point in time, there is only one dominant direction and one value of input correlation; and signal extraction proceeds directly from these signals.

However, particularly in complex acoustical environments (like the archetypal cocktail party), the human ear exhibits a certain degree of positional memory, or inertia, in that a briefly dominant sound from a given direction that is clearly localized will result in other, less distinctly localizable sounds from that general direction to be perceived as coming from the same source.

It is possible to emulate this effect in the decoding modules (and, indeed, in Pro Logic decoding as well) by adding an explicit mechanism to keep track of recently dominant directions and, during intervals of directionally ambiguous signal conditions, weight the output signal distribution toward recently dominant directions. This can enhance the perceived reproduced discreteness and stability of complex signal arrays.

### Modified Correlation and Selective Channel Mixing

As described, the spreading determination of each decoding module is based on the coincident cross correlation of its input signals. This may underestimate the amount of output signal content under some conditions. This will occur, for example, with a naturally recorded signal in which non-centered directions have slightly different arrival times, along with unequal amplitudes, resulting in a reduced correlation value. The effect may be exaggerated if wide-spaced microphones are used, with commensurately elongated interchannel delays. To compensate, the correlation calculation can be extended to cover a range of interchannel time delays, at the expense of slightly higher processing MIPS requirements. Also, since the neurons on the auditory nerve have an effective time constant of about 1 msec., more realistic correlation values may be obtained by first smoothing the rectified audio with a smoother having a 1 msec. time constant.

In addition, if a content producer has an existing 5.1 channel program with strongly uncorrelated channels, the evenness of the spread when processed with a channel translation decoder can be increased by slightly mixing adjacent channels, thereby increasing the correlation, which will cause the channel translation decoding module to provide a more even spread among its intermediate output channels. Such mixing can be done selectively, for example leaving the center front channel signal unmixed, to preserve the compactness of the dialog track.

### Loudness Compression/Expansion

When the encoding process involves mixing a larger number of channels to a smaller number, there is a potential for clipping of the encoded signal if some form of gain compensation is not provided. This problem exists as well for conventional matrix encoding, but is potentially of greater significance for channel translation, because the number of channels being mixed to a given output channel is greater. To avoid clipping in such cases, an overall gain scale factor is derived by the encoder and conveyed in the encoded bitstream to the decoder. Normally, this value is 0 dB, but can be set to a nonzero attenuating value by the encoder to avoid clipping, with the decoder providing an equivalent amount of compensating gain.

If the decoder is used to process an existing multichannel that lacks such a scale factor program (e.g., an existing 5.1 channel soundtrack), it could optionally use a fixed scale factor with an assumed value (presumably 0 dB), or apply an expansion function based on signal level and/or dynamics, or possibly make use of available metadata, such as a dialog normalization value, to adjust the decoder gain.

The present invention and its various aspects may be implemented in analog circuitry, or more probably as software functions performed in digital signal processors, programmed general-purpose digital computers, and/or special purpose digital computers. Interfaces between analog and digital signal streams may be performed in appropriate hardware and/or as functions in software and/or firmware.

1. A process for translating M audio input channels representing a soundfield to N audio output channels representing the same soundfield, wherein each channel is a single audio stream representing audio arriving from a direction, M and N are positive whole integers, and M is at least 2, comprising
generating one or more sets of output channels, each set having one or more output channels, wherein each set is associated with two or more spatially adjacent input channels and each output channel in a set is generated by a process that includes determining a measure of the correlation of the two or more input channels and the level interrelationships of the two or more input channels.

2. The process of claim 1 wherein there is one set of output channels associated with two input channels.

3. The process of claim 1 wherein one or more of said sets of output channels are associated with more than two input channels.

4 The process of claim 1 wherein one or more sets of output channels are associated with more input channels than one or more other sets of output channels and said process determines the correlation of input channels with which each set of output channels is associated according to a hierarchical order such that each set or sets is ranked according to the number of input channels with which its output channel or channels are associated, the greatest number of input channels having the highest ranking, and said processing processes sets in order according to their hierarchical order.

5. The process of claim 4 wherein said processing takes into account the results of processing higher order sets.

6. The process of claim 1 wherein said determining a measure of the correlation of the two or more input channels and the level interrelationships of the two or more input channels is performed in the frequency domain.

7. The process of claim 1 wherein said process employs nonlinear time constants.

8. The process of any of claims 1 or 3-8 wherein there are three or more input channels representing non-collinear directions.
